(19) United States
(12) Patent Application Publication
(10) Pub. No.: US 2024/0214063 A1
(43) Pub. Date: Jun. 27, 2024

(54) Jitter measurement of the Multi-level PAM Eye Diagram

(71) Applicant: Donghong Wu, Union City, CA (US)

(72) Inventor: Donghong Wu, Union City, CA (US)

(21) Appl. No.: 18/146,876

(22) Filed: Dec. 27, 2022

(51) Int. Cl. H04B 10/077; G06T 11/00; G06T 11/60

(52) U.S. Cl. CPC H04B 10/0775; G06T 11/001; G06T 11/60; G06T 2210/22

(57) ABSTRACT

A system and method based on the partition of sums of squares in analysis of variance (ANOVA) and image processing method can be used for jitter measurement of the multi-level PAM (PAMn) eye diagram. The system consists of importing a photo of the PAMn eye diagram, editing the eye diagram to obtain one Unit Interval (1UI) PAMn image, acquiring histograms of the single-lane and mixed-lane signals on a concentrated layer, and fitting Gaussians to the histograms. After obtaining the fitting parameters of the histograms, the random jitter RJ of the mixed-lane signals can be determined with the width of the mixed-lane signals, and the deterministic jitter DJ can be determined with the mean shift of the mixed-lane against the single-lane. Furthermore, the total jitter TJ of the mixed-lane signals is the sum of RJ and DJ.

### FIELD OF TECHNOLOGY

This invention generally relates to a system for jitter analysis of the serial signals and more specifically for jitter measurement of the multi-level Pulse-amplitude modulation (PAMn) eye diagrams in high-speed serial communication systems.

### BACKGROUND OF THE INVENTION

Pulse Amplitude Modulation (PAM), also known as serial communication, is a basic form of signal modulation in fiber optic communication. In serial communication, data information is encoded as a series of signal pulse amplitudes sent by the transmitter and then detected and decoded by the receiver at the far end. Traditional binary non-return-to-zero (NRZ) modulation in optical serial communications has two power levels representing a logic 0 and a logic 1, often referred to as PAM2. Its disadvantage is a higher channel-dependent loss as the modulation rate increases. Therefore, adding multiple levels in the modulation signals has become a more feasible solution in high-speed serial communication. The PAM4 signaling is the earliest industry standard among them, doubling the bandwidth as NRZ for the same data rate. Although the optical transceivers based on PAM4 have been widely used in the optical network, there are some critical manufacturing issues in the characterization, testing, and calibration of PAM4 signaling.

Jitter measurement of the eye diagram is one of the challenges. The eye diagram is an image on a high-speed digital oscilloscope, rearranging and superimposing the serial communication signals according to the modulation cycle intervals. When the signal width of the time scale on the scope is the two interval units (2UI), the NRZ eye diagram displays an eye pattern, while a PAM4 eye diagram may display three eye patterns from high to low. Compared with the NRZ eye diagram, PAM4 may have a significant distortion and noise, which leads to the reduction of signal-to-noise ratio and the increase of test complexity. Jitter analysis of the eye diagram is essential testing in high-speed serial communications because jitter levels and degraded waveforms significantly affect signal quality in communication networks. In jitter analysis, total jitter (TJ) is divided into two components, deterministic jitter (DJ) and random jitter (RJ). Deterministic jitter is a bounded jitter that is predictable and repeatable. Random jitter, called Gaussian jitter, is the unbounded jitter part of TJ. Both deterministic jitter and random jitter can be further classified by mechanisms.

In the existing solutions, the jitter analysis of the NRZ (PAM2) eye diagram measures the time variances of the rising and falling edges of the eye diagram at the crossing point of the eye. One can directly measure a peak-to-peak jitter and a random jitter from the horizontal pixel histogram at the eye cross point. A dual-Dirac jitter model was successfully used for estimating total jitter defined at a bit error ratio, TJ(BER), along the horizontal or time axis of the NRZ eye diagram. However, the jitter testing method cannot apply to the PAMn (n>2) eye diagrams due to the complex structures of the multiple crossing points along the time axis on the PAMn eye diagram.

Transmitter dispersion eye closure quaternary (TDECQ), as a measure of the vertical eye closure of the optical transmitter, is the first test solution about the signal distribution on the vertical central axis of the PAM4 eye diagram. During the test, the TDECQ system can improve the eye quality through continuous measurement of the parameter, feedback, and adjustment with hardware components, such as a multi-tap sensor and a feed-forward equalizer, in the oscilloscope. However, one can only get limited information from the TDECQ testing. For example, the system in scope adjusts all three eyes on the PAM4 eye diagram simultaneously but cannot measure and analyze the specific eye to be concerned. The TDECQ parameter is a measure of the reshaped eye diagram after a series of adjusting processes, so the testing result is only the relative value of the initial state of a device under test (DUT). In addition, one cannot establish a relationship between the TDECQ parameter and the jitter analysis of the PAM4 signals.

In the present disclosure, one-way analysis of variance (ANOVA) in statistics is used for the jitter measurement of the mixed-lane signals in the PAMn eye diagram. Variances or jitter, the squares of the standard deviations, are a measure of dispersion in statistics. One-Way ANOVA is a technique to determine sample variances by comparing means of multiple samples. One may determine three components of jitter, RJ, DJ, and TJ of the mixed-lane signals in the concentrated layer on the PAMn eye diagram with the mathematical formulas of the partition of sums of squares in ANOVA. The statistical model reveals a general algorithm and the test parameters used for the jitter analysis of the PAMn signals. The concentrated layers at the vertical center on the PAMn eye diagram are mixed signals from the different transition lanes. Because each lane signal consists of massive mini dots, one may only recognize the central line of a transition lane and its blurred contours on the image, so identifying the components of RJ, DJ, and TJ in the PAMn eye diagram becomes challenging. In the present invention, a novel jitter measurement method of the mixed-lane signals on the PAMn eye diagram is disclosed, implementing the partition of sums of squares in ANOVA and image processing methods.

### BRIEF DESCRIPTION OF DRAWINGS

The present invention is illustrated by way of example, and not by way of limitation, in the figures of the accompanying drawings and in which reference numerals refer to similar elements.

The following terms may be used with reference to the figures and description set forth herein. A 1UI may be one unit interval on the x scale of an oscilloscope. A PAMn eye diagram may be an image with 2UI or more in the x scale. A transition lane or lane on the 1UI PAMn image may be an imaging band comprising many image dots from the same transition process from a Start state to an End state (Start End). A mixed-lane or level may be a concentrated layer on the PAMn eye diagram, labeled with the logic coding state from zero to n-1, n is the multi-level. A hlane may be a horizontal lane with the same start and end levels on the 1UI PAMn image. A tlane may be a transition lane with different start and end levels on the 1UI PAMn image. For instance, 00 is the horizontal lane with the same start and end levels, and 30 is the transition lane from level 3 to level 0 on the 1UI PAMn image. A lane signal may be a single lane signal sampled in the middle of a level, and a level signal may be a mixed lane signal sampled at either side of a level. A lane histogram may be a vertical pixel profile of the lane signal at the sampling point, and a level histogram may be a vertical pixel profile of the level signal at the sampling point.

FIG. 1 illustrates a flow chart of an exemplary method for jitter measurement of the PAMn eye diagram with the partition of sums of squares in ANOVA and image process method, in accordance with an embodiment of the present invention;

FIG. 2 illustrates a flow chart of an exemplary method for editing a PAMn eye diagram to obtain the 1UI PAM4 image, in accordance with an embodiment of the present invention;

FIG. 3 illustrates an example of sampling three points on a PAMn eye diagram to obtain a 1UI PAMn image;

FIG. 4 illustrates an example of sampling the lane signal and the level signal on a 1UI PAM4 image;

FIG. 5 illustrates a flow chart of an exemplary method for the jitter measurement of a level histogram on the 1UI PAMn image, in accordance with an embodiment of the present invention;

FIG. 6 illustrates an example of explaining the algorithm using the partition of sums of squares in ANOVA to determine the jitter components, RJ, DJ, and TJ of a level histogram;

FIG. 7 illustrates an example of reporting jitter measurements of four levels in a PAM4 image.

### DETAILED DESCRIPTION OF THE INVENTION

Embodiments of methods for jitter measurement for the PAMn eye diagram are described herein. In the following description, some specific details are set forth to provide a thorough understanding of the embodiments of the invention. The particular models, algorithms, and process logic flows in the invention can be combined in any suitable manner into one or more embodiments.

Unlike the 2UI scale in the PAMn eye diagram, the novel jitter measurement method in the present disclosure uses the 1UI scale in the PAMn image for the statistical model of jitter analysis. The 1UI model simplifies the complexity of the PAMn signals and reduces the number of the transition lanes analyzed to half. Notably, the new model allows one to focus the jitter analysis of the 1UI PAMn image on a concentrated layer or level and two particular signal areas on the level, the single-lane or lane signal and the mixed-lane or level signal, resulting in the identification of the jitter components, RJ and DJ.

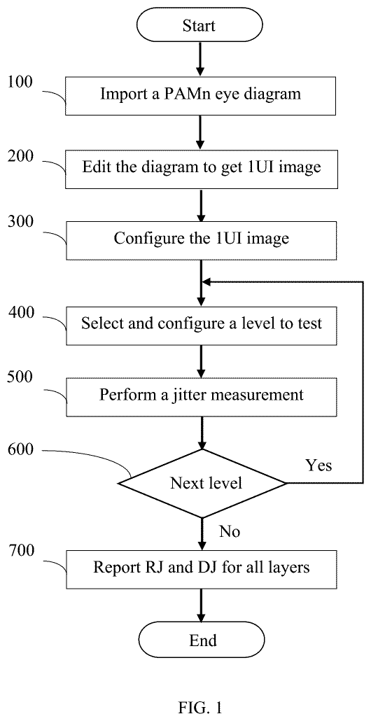

FIG. 1 illustrates a flow chart of an exemplary method for jitter measurement of the PAMn eye diagram with the partition of sums of squares in ANOVA and image process method, in accordance with an embodiment of the present invention. A software system that integrates the jitter analysis model, algorithms, and image process method is used to perform the jitter measurement of the PAMn eye diagram. First, a color photo or a digital file of the PAMn eye diagram in a 2UI scale or more, taken from the oscilloscope screen, is imported into the system 100. Secondly, with the image processing method, the PAMn eye diagram is edited to a 1UI PAMn image 200. Next, the 1UI image may be further configured in color, size, and scales for jitter measurement 300. After that, the system may perform a jitter measurement in a sequence of procedures based on the partition of sums of squares in ANOVA and the image processing method to determine the jitter components of the level histogram 500. Finally, the jitter components, RJ, DJ, and TJ of all levels in the PAMn image may be reported after completing jitter measurements of all levels 700.

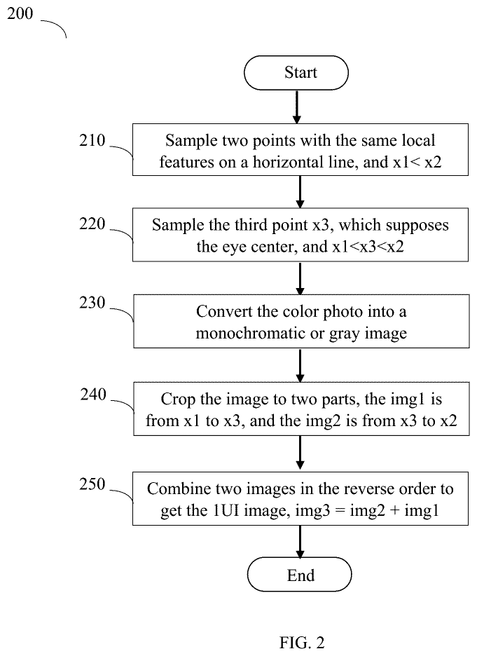

FIG. 2 illustrates a flow chart of an exemplary method for modifying a PAMn eye diagram to a 1UI PAMn image, in accordance with an embodiment of the present invention. In a step 210 of method 200, two sampling points, (x1, y1) and (x2, y2), may be taken at a horizontal line on the eye diagram where the two sampling points have the same local features and y1=y2. The third sampling point (x3, y3) between x1 and x2, the expected vertical edge of the 1UI PAMn image, may be taken in a step 220 of method 200. The image processing method may convert the color PAMn eye diagram to a monochromatic or gray image in a step 230 of method 200, and then crop the 2UI diagram into two images, where img1 is from x1 to x3, and img2 is from x3 to x2 in a step 240 of method 200. Finally, the image processing method may concatenate two images in the reverse order, img3=img2+img1, in a step 240 of method 200, to obtain a new PAMn image with the 1UI image width.

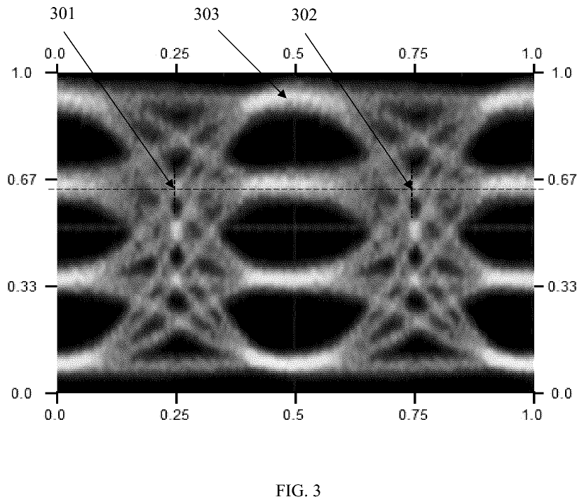

FIG. 3 illustrates an example of sampling three points on a PAM4 eye diagram to obtain a 1UI PAM4 image. To get the new image with a 1UI width, one may sample two points with the same local texture structures at a horizontal line in the eye diagram, 301 and 302, for example. The third sampling point, 303, is to set the edge position of the 1UI PAM4 image or the center position of the 2UI PAM4 eye diagram. Once the three sampling points are selected, the system may modify the PAM4 eye diagram with the image processing method in method 200 to get a PAMn image with a 1UI image width and the user-defined edge position of the 1UI image.

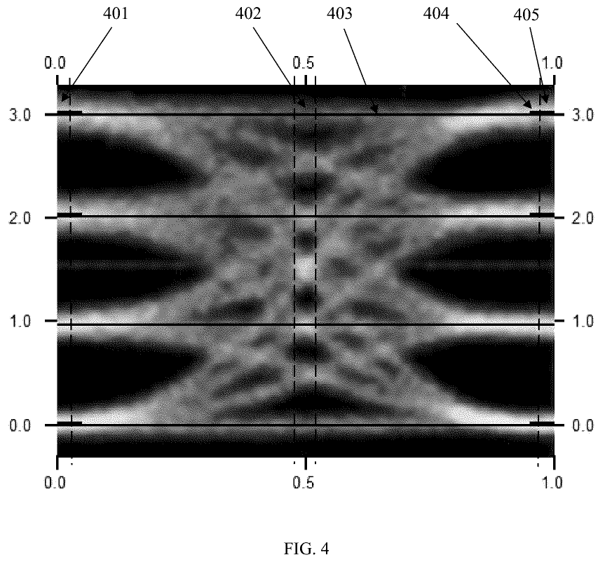

FIG. 4 illustrates an example of sampling the lane signal and the level signal of a 1UI PAM4 image. The lane signal may be sampled in the middle 402 of a level in the 1UI PAM4 image. There are two types of texture structures in the lane signal area. One is the lane signal at the top level 3 or the bottom level 0 in that no other transition lanes are crossing, so the vertical histogram at the sample point may only contain a single lane signal. Another type is the lane signals of other levels in that a hlane intersects with some tlanes in the center area of the 1UI PAM4 image. In the second case, one may sample the brightest point in the local area of the lane signal and set a pixel threshold to acquire the pixel histogram of a lane signal to get the identical test parameters of the lane signal. The level signal may be sampled near one of the ends of level 401 or 405, where the level histogram is the mixed signals of the multiple transition lanes with either the same start state or the same end state. After acquiring the vertical pixel histogram at a sampling point, the system may fit gaussian to the histogram to gain a mean and a standard deviation of the signal. In the 1UI statistical model, the lane signal of a level may remain constant so that the lane mean 403 is drawn as a horizontal line through the 1UI image. On the other hand, the level mean may change with the sampling point close to the end of a level, so only two short line segments of the level mean are drawn in 404, for example.

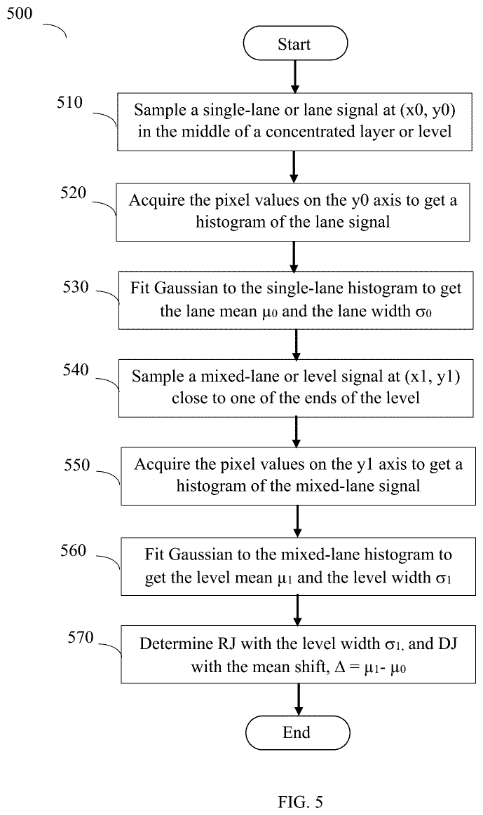

FIG. 5 illustrates a flow chart of an exemplary method for the jitter measurement of a level histogram on the 1UI PAMn image, in accordance with an embodiment of the present invention. In a step 510 of method 500, one may sample the single-lane signal at (x0, y0) in the middle of a level and then acquire the lane histogram on the y0 axis if the level is either the top or bottom one or set a pixel threshold to acquire the lane histogram if the level is others, in a step 520 of method 500. By fitting gaussian to the lane histogram, one may obtain the jitter parameters, the lane mean μ₀, and the lane width go in a step 530 of method 500. Next, one may sample the mixed-lane or level signal at (x1, y1) close to either side of the level in a step 540 of method 500 to acquire the level histogram on the y1 axis in a step 550 of method 500. After fitting gaussian to the level histogram, one may get the level mean μ₁ and the level width σ₁ in a step 560 of method 500. Finally, one may determine the jitter components of the level histogram in that the random jitter is the level width, RJ=σ₁, and the deterministic jitter is the mean shift of the level mean against the lane mean, DJ=μ₁−μ₀, in a step 570 of method 500.

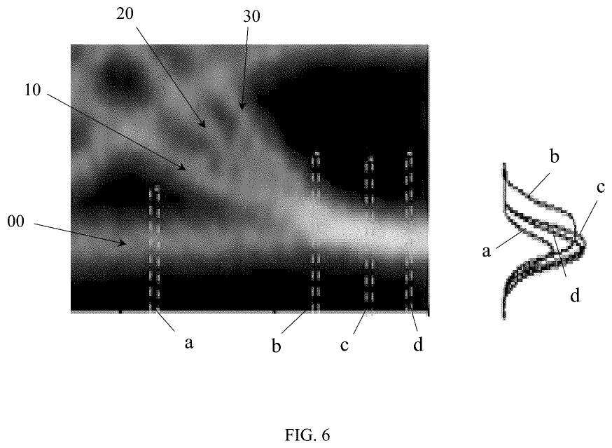

FIG. 6 illustrates an example of explaining the algorithm using the partition of sums of squares in ANOVA to determine the jitter components, RJ, DJ, and TJ of a level histogram. The image on the left is the lower right corner of the 1UI PAM4 image, in which there are four transition lanes, a hlane 00 and three tlane, 10, 20, and 30. The four histograms, a, b, c, and d, on the right of the image are from four corresponding vertical slots on the image. The histogram a may contain only the lane signal, and three histograms, b, c, and d, are the level signals mixed by the four transition lanes.

### THE DISCLOSED ALGORITHM

The algorithm disclosed herein is based on recognizing factors.
1. A level histogram in the 1UI PAMn image may be a typical statistical system in which the pixel value of signals in each transition lanes is a dependent variable approximately normally distributed, and the transition lanes are categorical and independent groups. Therefore, three jitter components, RJ, DJ, and TJ, of the level histogram may be determined with mathematical formulas of the partition of sums of squares in ANOVA, RJ=sum of squares within (or Errors), DJ=sum of squares between (or Treatment), and TJ=sum of squares total.
2. A level histogram containing the signals of all transition lanes is the total jitter TJ of a level at the sampling point. The mean and width of the level histogram vary with the sampling point, and the level width may reach the minimum when the sample point closes to one of the ends of the level, as shown in FIG. 6, similar to the crossing point on the NRZ eye diagram.
3. The random jitter RJ of a level may be measured with a standard deviation or width σ of the level histogram, which is consistence with RJ measurement of the NRZ eye diagram.
4. The total jitter, TJ=RJ+DJ and DJ≥0. In a particular case without dispersion in the level histogram, all transition lanes, a hlane and other tlanes are symmetrical overlaps on each other around the level mean at the sampling point, so that DJ=0, and TJ=RJ, which is the minimum of TJ. In addition, the lane mean of an ideal level on the 1UI PAMn image may remain constant, indicating that the lane mean is independent of the sampling point. Therefore, the lane mean μ₀ of a level may be defined as the reference line, and the mean shiftΔ of the level mean against the lane mean may be used as a variable to measure DJ, i.e., DJ=Δ.
5. The statistical model and algorithm of jitter measurement may apply to different sampling points on either the x or y axes of the 1UI PAMn image. In a generic case of the level histogram's profile containing more than one peak in shape, the system may fit more Gaussians to the pixel profile. If the number of peaks on the pixel profile is n, the random jitter of a level histogram, or the total level width, may be the square root of sum of squares of widths,

$$RJ = \sqrt{{σ}_{1}^{2} + {σ}_{2}^{2} + … + {σ}_{n}^{2}}$$

where σᵢ is the width of the peak i. The deterministic jitter of a level histogram, or the total mean shift, may be the square root of sum of squares of the mean shifts,

$$DJ = \sqrt{{Δ}_{1}^{2} + {Δ}_{2}^{2} + … + {Δ}_{n}^{2}}$$

where Δᵢ=μᵢμ₀ is the mean shift of the peak i against the reference line or the lane mean μ₀.

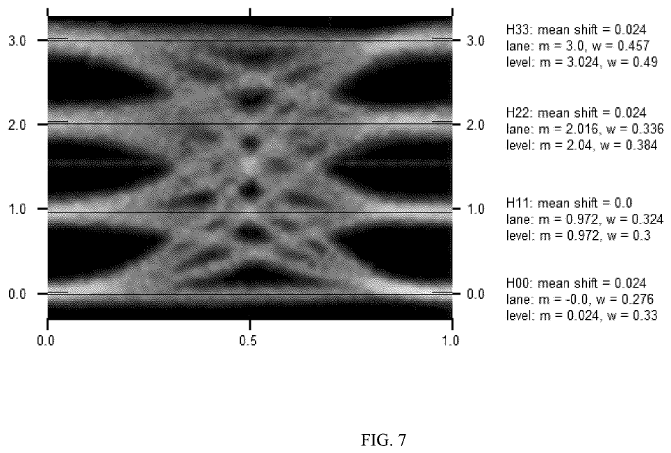

FIG. 7 illustrates an example of reporting jitter measurements of four levels in a PAM4 image. The test parameters of a jitter measurement include a lane mean and a lane width, a level mean and a level width, and the mean shift. One can further give the jitter components of a level that RJ is the level width and DJ is the mean shift.

Notably, the system integrating the statistical model, algorithm, and image processing method may be a generic solution for the jitter measurement of amplitude-modulated signaling of electromagnetic waves in different frequencies and baud rates.

1. A method comprising the steps for:
importing a photo or a digital file of the multi-level Pulse Amplitude Modulation (PAMn) eye diagram;
editing the PAMn eye diagram to a 1UI PAMn image with image processing method;
configuring color, size, and scale of the 1UI image for jitter measurement;
performing a jitter measurement for each level;
reporting the jitter components, RJ, DJ, and TJ of all levels on the 1UI PAMn image.

2. The method of claim 1, in which said steps of editing the PAMn eye diagram to a 1UI PAMn image with image processing method;
sampling two points, (x1, y1) and (x2, y2), with the same local features on a horizontal line on the PAMn eye diagram, and x1<x2;
sampling the third point (x3, y3) at the eye center of the PAMn eye diagram, and x1<x3<x2;
converting the color image into a monochromatic or gray image;
vertically cropping the eye diagram into two images, img1 is from x1 to x3, and img2 is from x3 to x2;
combining two images in a reverse order, img3=img2+img1, to get the 1UI PAMn image.

3. The method of claim 1, in which said steps of performing the jitter measurement for each level:
sampling a lane signal in the middle of a level;
acquiring a lane histogram on the vertical axis at the lane sampling point;
fitting gaussian to the lane histogram to get the lane mean and the lane width;
sampling a level signal close to one of the ends of the level;
acquiring a level histogram on the vertical axis at the level sampling point;
fitting gaussian to the level histogram to get the level mean and the level width;
determining three jitter components, RJ, DJ, and TJ, of the level.

4. The method of claim 3, in which said steps of determining three jitter components, RJ, DJ, and TJ, of the level:
checking the pixel profile of a level histogram to get the number n of the local peaks;
fitting n Gaussians to the pixel profile;
finding a mean and a standard deviation for each local peak;
determining RJ of the level with the total width of the level histogram, which is the square root of sum of squares of widths;
determining DJ of the level with the total mean shift of the level histogram, which is the square root of sum of squares of the mean shifts;
determining TJ of the level histogram with sum of RJ and DJ.
